(19) United States
(12) Patent Application Publication
(10) Pub. No.: US 2020/0122741 A1
(43) Pub. Date: Apr. 23, 2020

(54) System and Method for Providing User-Specific Driver Assistance

(71) Applicant: Bendix Commercial Vehicle Systems LLC, Elyria, OH (US)

(72) Inventors: Andreas U. KUEHNLE, Villa Park, CA (US); Hans Molin, Mission Viejo, CA (US); Rohan N. Nachnolkar, Elyria, OH (US)

(21) Appl. No.: 16/166,720

(22) Filed: Oct. 22, 2018

(51) Int. Cl. B60W 50/14; B60W 50/08; B60W 40/09

(52) U.S. Cl. CPC B60W 50/14; B60W 40/09; B60W 50/085

(57) ABSTRACT

A method for providing user-specific driver assistance includes storing, in a vehicle, warning threshold preset values used to provide driver assistance warnings, and identifying a driver of the vehicle based on driver identification information. Sensors provide driver behavior data for the identified driver, which is then compared to desired driver behavior data. A modified warning value specific to the identified driver is then determined based at least in part on a result of the comparison. One or more of the plurality of warning threshold preset values may be updated based on the modified warning value, and a driver assistance warning may be provided to the identified driver in accordance with the updated one or more of the plurality of warning threshold preset values.

### FIELD OF THE INVENTION

The invention relates to providing user-specific driver assistance and, in particular, to providing user-specific driver assistance warnings and/or user-specific lessons and feedback based on undesirable driver behavior.

### BACKGROUND

Conventionally, driver assistance systems have been used in vehicles to warn and assist drivers based on a presently-existing state or condition, such as through the use of lane departure warning systems, distance following systems, parking assistance systems and the like. However, such prior art systems are limited in that they are do not take into account the specific abilities and/or tendencies of a given driver. For example, a lane departure warning system that uses the “Time to Line Crossing” measure works by measuring the lateral velocity of a vehicle relative to the lane marking, calculating how much time is left until the line is reached (=distance remaining/lateral velocity), and warning when this time is smaller than some predefined threshold value (e.g., 0.5 seconds), thereby indicating that the lane change is unintentional. However, since this threshold value is the same for all drivers of the vehicle, the lane departure warning system cannot take into account drivers who may be less experienced, have slower reaction times, etc. and who, as a result, would benefit from an earlier warning.

Similarly, conventional driver assistance systems also provide following distance warnings based on a defined distance to a vehicle ahead and/or headway time, which is the elapsed time between the time that one car finishes passing a fixed point and the instant that the next car begins to pass that point. Here again, such following distance warnings are based on predefined threshold values that are applied to all drivers, and therefore do not take into account the experience level, or the current abilities or fatigue level of the particular driver of the vehicle. Moreover, such following distance warnings may correspond to all vehicles so as not to take into account the particular characteristics or requirements of the particular vehicle being driven.

As such, there is a need in the art for a system and method for to provide customized or user-specific driver assistance.

### SUMMARY OF THE INVENTION

In one embodiment of the invention, a driver warning and behavior modification device includes a signal interface to a plurality of sensors, a transceiver module and a memory configured to store a plurality of instructions and to store a plurality of warning threshold preset values used to provide driver assistance warnings. The device also includes a processor, coupled to the plurality of sensors via the signal interface, transceiver module and memory, where the processor is configured to execute the instructions to identify the driver of the vehicle and to receive, from the plurality of sensors, driver behavior data corresponding to the driver. The driver behavior data corresponds to one or both of statistical data and a type of vehicle event.

The processor is further configured to execute the instructions to receive, from a server using the transceiver module, one or both of a modified warning value specific to the identified driver and desired driver behavior data, wherein the modified warning value is based at least in part on comparing the driver behavior data for the identified driver to desired driver behavior data. One or more of the plurality of warning threshold preset values are then updated based on the modified warning value, and a driver assistance warning is provided to the identified driver in accordance with the updated one or more of the plurality of warning threshold preset values.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a diagram of an overview of a fleet management system configured in accordance with the principles of the invention.

FIG. 2 is a block diagram that illustrates one embodiment of a vehicle-based computer system configured to implement one or more aspects of the invention.

FIG. 3 depicts an arrangement in which the vehicle-based computer system of FIG. 2 can be used to implement one or more aspects of the invention in the fleet management system of FIG. 1.

FIG. 4 illustrates a diagram comparing desired driver behavior and actual driver behavior with respect to headway time.

FIG. 5 illustrates a diagram showing how driver behavior can be improved with respect to headway time using one or more aspect of the invention.

FIG. 6 illustrates one embodiment of how predefined warning threshold preset values can be modified in accordance with the principles of the invention

FIG. 7 illustrates a diagram showing one aspect of the invention in which the vehicle's braking force or the vehicle's (on-the-pavement) wheel angle or rate can be controlled in a modified fashion as a function of pedal pressure or steering wheel angle or rate.

### DESCRIPTION OF EXEMPLARY EMBODIMENTS OF THE INVENTION

In the following description of the present invention reference is made to the accompanying figures which form a part thereof, and in which is shown, by way of illustration, exemplary embodiments illustrating the principles of the present invention and how it is practiced. Other embodiments can be utilized to practice the present invention and structural and functional changes can be made thereto without departing from the scope of the present invention

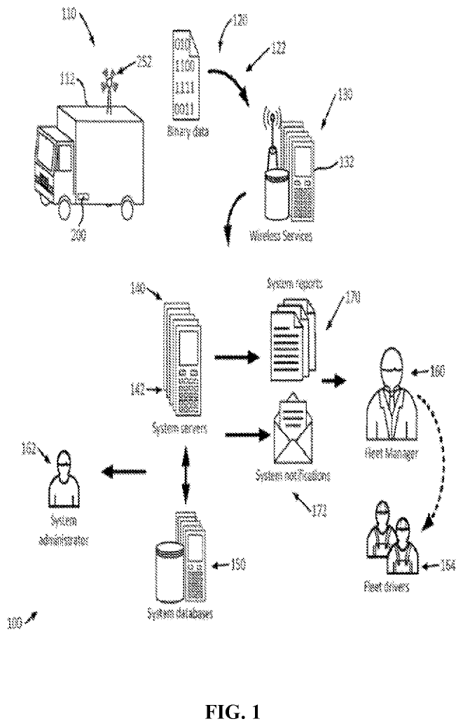

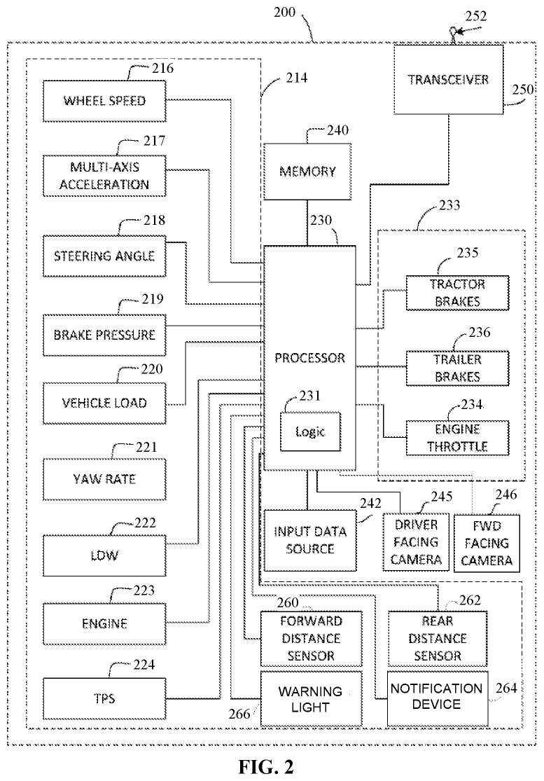

Referring now to the drawings, FIG. 1 illustrates an overview of a fleet management and reporting system 100 in accordance with one embodiment. In the example embodiment of the present invention, vehicles 110, such as trucks and cars, and particularly fleet vehicles 112, are configured with a driver warning and behavior modification device 200 (see FIG. 2) that generates actual driver behavior and event data relating to, in the example of a fleet of trucks, truck start, truck stop, and safety event data. Such system may include for example a Lane Departure Warning (LOW) system 222 (FIG. 2) that generates signals indicative of actual driver behavior, such as driver and vehicle events regarding in the example of the fleet of trucks, truck lane wandering or crossing. Additionally, secondary systems to be described in greater detail below with reference to FIG. 2 carried by the vehicles or installed in the vehicle systems such as one or more video cameras, radar, lidar, transmission, engine, tire pressure monitoring and braking systems for example may generate additional safety event data and driver behavior data. Front facing cameras, radar and lidar-based system may also be used to provide data relating to driver behavior in the context of following distance, headway time, response to speed signs, and anticipation of needed slowing. Third-party systems that generate proprietary safety events or data representative of detected safety events may also be involved. For example, the embodiments of the present invention may include software code implementing a Bendix® Wingman® ACB system available from Bendix Commercial Vehicle Systems LLC that captures proprietary safety events and other data relating to the proprietary safety events and/or relating to the operation of the vehicle by one or more vehicle operators or drivers.

With continued reference to FIG. 1, these driver behavior and event data 120 may be selectively sent via communication links 122 to network servers 132 of one or more service providers 130. Communication service providers 130 may utilize servers 132 (only one shown for ease of illustration) that collect data 120 provided by the vehicles 112. Each may also provide a web service by which users can report on or download data.

One or more servers 140 of the fleet management and reporting system 100 are configured to selectively download or otherwise retrieve data either directly from the vehicles 110 via the service providers 130 or from collection servers 132 which may be third party servers from one or more various telematics suppliers. The one or more servers 140 of the fleet management and reporting system 100 are configured to initiate processing of the driver behavior and vehicle event data in manners to be described in greater detail below. A web application 142 executable on the one or more servers 140 of the fleet management and reporting system 100 includes a dynamic graphical user interface for fleet managers 160 and administrators 162 to view all of the information once it is processed. The subject fleet management and reporting system 100 of the example embodiment also includes one or more databases 150 configured to selectively store all event information provided from the vehicles 112 in the fleet 110 for one or more designated time intervals, including raw and post-processed trip data.

In accordance with the example embodiment, the system administrators 162 are users who are provided with interfaces to configure and manage fleets, monitor platform performance, view alerts issued by the platform, and view raw driver behavior and event data and subsequent processing logs and/or views. Fleet managers 160 may view event information for their respective fleet for internal processing. These events can arrive via user-initiated reports 170 in the web application 142 executable on the one or more servers 140, or via email or other notifications 172. Fleet managers 160 may, depending on internal policies and processes or for other reasons, also interface with individual drivers 164 regarding performance goals, corrections, reports, or coaching

The subject fleet management and reporting system 100 of the example embodiment therefore offers a long list of functions and features to the end user. All have been designed to be driver centric, so that fleet managers 160 may focus their attention on driver education, training, and performance improvement. One of the primary beneficial and novel uses of the system 100 is to obtain driver specific-performance and behavior data and the ability to compare with the drivers of the fleet as a whole in order to provide user-specific driver assistance in the form of customized driver assistance warning thresholds, as well as those in the form of feedback, coaching and/or other corrective action. For example, such customized driver assistance warning thresholds may relate to headway time/safe following distance warnings, lane departure warnings based on “Time to Line Crossing” measurements, and warnings relating to braking and or obstacle avoidance events. Others include anticipatory speed adaptation, sufficiently early blinker setting for lane changes, wiper speed settings (cameras may be used to measure rain intensity), shifting in anticipation of downhills, uphills, and stopping.

Referring now to FIG. 2, depicted is a schematic block diagram that illustrates details of a driver warning and behavior modification device mentioned above, and which is configured to be used in accordance with one or more exemplary embodiments of the invention. According to principles of the example embodiment as illustrated, the in-vehicle driver warning and behavior modification device 200 may be adapted to detect a variety of operational parameters and conditions of the vehicle and the driver's interaction therewith and, based thereon, to predict and/or prevent a possible vehicle incident in order to warn the driver and/or undertake an evasive maneuver ahead of time, as may be needed or desired, for example, to maintain vehicle stability or to maintain the vehicle following distance relative to other vehicles.

In the exemplary embodiment of FIG. 2, the driver warning and behavior modification device 200 may include one or more devices or systems 214 for providing input data indicative of one or more operating parameters or one or more conditions of a commercial vehicle. Alternatively, the driver warning and behavior modification device 200 may include a signal interface for receiving signals from the one or more devices or systems 214, which may be configured separate from device 200. For example, the devices 214 may be one or more sensors, such as but not limited to, one or more wheel speed sensors 216, one or more acceleration sensors such as multi-axis acceleration sensors 217, a steering angle sensor 218, a brake pressure sensor 219, one or more vehicle load sensors 220, a yaw rate sensor 221, a lane departure warning (LDW) sensor or system 222, one or more engine speed or condition sensors 223, and a tire pressure (TPMS) monitoring system 224. The driver warning and behavior modification device 200 may also utilize additional devices or sensors in the exemplary embodiment including for example a forward distance sensor 260 and a rear distance sensor 262 (e.g., radar, lidar, etc.) which may be part of the driver assistance system and in any event usable for measuring actual driver behavior relating to following distance, headway time, and traffic/road situation response. Other sensors and/or actuators or power generation devices or combinations thereof may be used of otherwise provided as well, and one or more devices or sensors may be combined into a single unit as may be necessary and/or desired.

The driver warning and behavior modification device 200 may also include warning light(s) 266 and/or notification device 264, which may also be part of the driver assistance system, and may be usable to provide the aforementioned headway time/safe following distance warnings, lane departure warnings, and warnings relating to braking and or obstacle avoidance events. It should be appreciated that the notification device 264 may provide for one or more types of warnings, including haptic, visual and audible warning. Such warnings may be provided to the driver based on default thresholds established by the fleet manager/administrator, which may be modified in accordance with the principles of the invention as detailed herein.

The driver warning and behavior modification device 200 may also include a logic applying arrangement such as a controller or processor 230 and control logic 231, in communication with the one or more devices or systems 214. The processor 230 may include one or more inputs for receiving input data from the devices or systems 214. The processor 230 may be adapted to process the input data and compare the raw or processed input data to one or more stored threshold values or desired averages, or to process the input data and compare the raw or processed input data to one or more circumstance-dependent desired value.

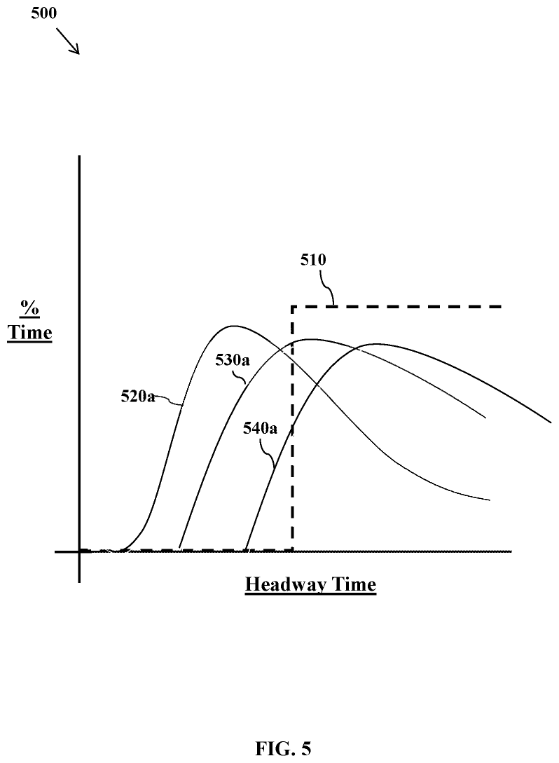

The processor 230 may also include one or more outputs for delivering a control signal to one or more vehicle systems 233 based on the comparison (e.g., to perform the operations of blocks 530-550 of FIG. 5). The control signal may instruct the systems 233 to provide one or more types of driver assistance warnings (e.g., warnings relating to braking and or obstacle avoidance events) and/or to intervene in the operation of the vehicle to initiate corrective action. For example, the processor 230 may generate and send the control signal to an engine electronic control unit or an actuating device to reduce the engine throttle 234 and slow the vehicle down. Further, the processor 230 may send the control signal to one or more vehicle brake systems 235, 236 to selectively engage the brakes (e.g., a differential braking operation). A variety of corrective actions may be possible and multiple corrective actions may be initiated at the same time.

In certain embodiments, a driver assistance warning may be provided as a first step and, if corrective action is not taken within a predetermined period of time, an intervention of the vehicle's operation may be initiated in order to perform a corrective action (e.g., automatically braking the vehicle or applying a steering correction).

The driver warning and behavior modification device 200 may also include a memory portion 240 for storing and accessing system information, such as for example the system control logic 231. The memory portion 240, however, may be separate from the processor 230. The sensors 214 and processor 230 may be part of a preexisting system or use components of a preexisting system.

The driver warning and behavior modification device 200 may also include a source of input data 242 indicative of a configuration/condition of a commercial vehicle. The processor 230 may sense or estimate the configuration/condition of the vehicle based on the input data, and may select a control tuning mode or sensitivity based on the vehicle configuration/condition. The processor 230 may compare the operational data received from the sensors or systems 214 to the information provided by the tuning.

In addition, the driver warning and behavior modification device 200 is operatively coupled with one or more driver facing imaging devices, shown in the example embodiment for simplicity and ease of illustration as a single driver facing camera 245 that is trained on the driver and/or trained on the interior of the cab of the commercial vehicle. However, it should be appreciated that one or more physical video cameras may be disposed on the vehicle such as, for example, a video camera on each corner of the vehicle, one or more cameras mounted remotely and in operative communication with the driver warning and behavior modification device 200 such as a forward facing camera 246 to record images of the roadway ahead of the vehicle. In the example embodiments, driver behavior data can be collected directly using the driver facing camera 245 in accordance with a detected driver head position, hand position, or the like, within the vehicle being operated by the vehicle. In addition, driver identity can be determined based on facial recognition technology and/or body/posture template matching, as discussed further below.

In further example embodiments, the driver behavior data is collected directly using the driver facing camera 245 in accordance with a detected head pose of the driver. For purposes of this description of the example embodiments and for ease of reference, “head pose” is that set of angles describing the orientation of the driver's head, that is, pitch (driver looking down or up), yaw (driver looking left or right), and roll (driver tilting his/her head to the left or right).

Still yet further, the driver warning and behavior modification device 200 may also include a transmitter/receiver (transceiver) module 250 such as, for example, a radio frequency (RF) transmitter including one or more antennas 252 for wireless communication of the automated control requests, GPS data, one or more various vehicle configuration and/or condition data, or the like between the vehicles and one or more destinations such as, for example, to one or more services (not shown) having a corresponding receiver and antenna. The transmitter/receiver (transceiver) module 250 may include various functional parts of sub portions operatively coupled with a platoon control unit including for example a communication receiver portion, a global position sensor (GPS) receiver portion, and a communication transmitter. For communication of specific information and/or data, the communication receiver and transmitter portions may include one or more functional and/or operational communication interface portions as well.

The processor 230 is operative to combine selected ones of the collected signals from the sensor systems described above into processed data representative of higher level vehicle condition data such as, for example, data from the multi-axis acceleration sensors 217 may be combined with the data from the steering angle sensor 218 to determine excessive curve speed event data. Other hybrid event data relatable to the vehicle and driver of the vehicle and obtainable from combining one or more selected raw data items from the sensors includes, for example and without limitation, excessive braking event data, excessive curve speed event data, lane departure warning event data, excessive lane departure event data, lane change without turn signal event data, loss of video tracking event data, LDW system disabled event data, distance alert event data, forward collision warning event data, haptic warning event data, collision mitigation braking event data, ATC event data, ESC event data, RSC event data, ABS event data, TPMS event data, engine system event data, average following distance event data, average fuel consumption event data, average ACC usage event data, and late speed adaptation (such as that given by signage or exiting).

The driver warning and behavior modification device 200 of FIG. 2 is suitable for executing embodiments of one or more software systems or modules that perform vehicle brake strategies and vehicle braking control methods according to the subject application. The example driver warning and behavior modification device 200 may include a bus or other communication mechanism for communicating information, and a processor 230 coupled with the bus for processing information. The computer system includes a main memory 240, such as random access memory (RAM) or other dynamic storage device for storing instructions and loaded portions of the trained neural network to be executed by the processor 230, and read only memory (ROM) or other static storage device for storing other static information and instructions for the processor 230. Other storage devices may also suitably be provided for storing information and instructions as necessary or desired.

Instructions may be read into the main memory 240 from another computer-readable medium, such as another storage device of via the transceiver 250. Execution of the sequences of instructions contained in main memory 240 causes the processor 230 to perform the process steps described herein. In an alternative implementation, hard-wired circuitry may be used in place of or in combination with software instructions to implement the invention. Thus implementations of the example embodiments are not limited to any specific combination of hardware circuitry and software.

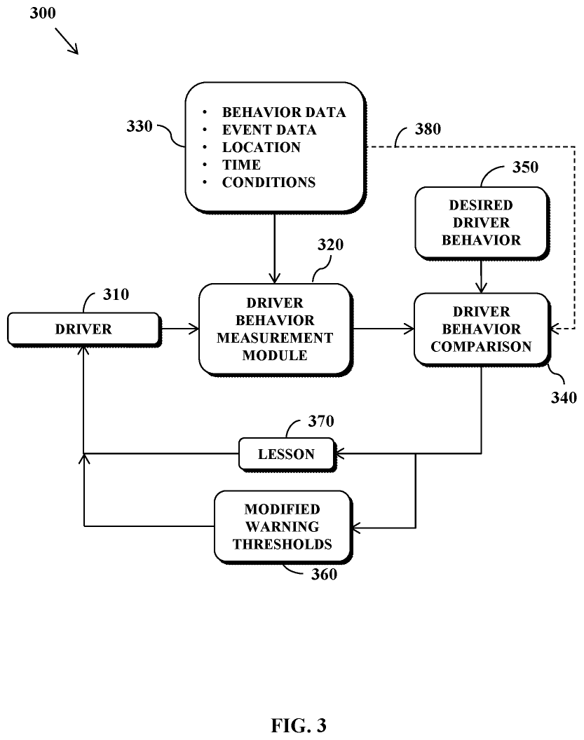

Referring now to FIG. 3, an arrangement 300 for implementing one or more aspects of the invention is shown. The arrangement 300 includes a driver 310 of a vehicle 112, as described above, which is configured with a driver warning and behavior modification device (e.g., device 200) that provides driver assistance warnings and generates driver behavior and event data indicative of one how a driver behaves generally or in relation to one or more vehicle events, such as a lane departure, headway time, excessive braking, excessive lateral acceleration, rollover, etc.

The arrangement 300 of FIG. 3 further comprises a driver behavior measurement module 320 which is configured to receive driver identification information from driver 310, and also to receive driver behavior and event data from the driver warning and behavior modification device 200 of the vehicle 112, along with possibly the location, time and conditions under which an event in question occurred.

It should be appreciated that driver identification information may be obtained from a driver facing camera (e.g., camera 245) using facial recognition technology and/or body/posture template matching, or from an in-vehicle microphone (not shown) using voice recognition technology. A driver may further identify itself by entering a user code into an input device in the vehicle, or using short range wireless technology, such as near field communication, Bluetooth, etc.

Driver behavior and event data 330, which may include information relating to location, time and conditions under which the behavior and events occurred, may also be provided to the driver behavior measurement module 320, as shown in FIG. 3. As noted above, driver behavior data and event data 330 may include how a driver behaves generally (e.g., average following distance, average headway time, average response to speed signs, anticipation of needed slowing, lane departure activity, average rate of braking, and average rate of acceleration, etc.) and/or in relation to one or more detected vehicle events, such as an unintended lane departure, insufficient headway time, excessive braking, excessive lateral acceleration, rollover, failure to obey traffic signs, or other deviations from proper protocol.

The driver behavior and event data 330 may then be transmitted to a comparison module 340, which is preferably part of the aforementioned system servers 140, but may alternatively reside on the vehicle as well. Comparison module 340 is further configured to request and/or receive desired driver behavior data 350, which may comprise predefined fleet-wide driving parameters and/or predefined warning threshold preset values or desired average or percentiles set by fleet managers 160 and/or administrators 162 defining how driver's should behave/react in various situations. For example, driving parameters relating to maintaining headway time and following distance may be defined (e.g., maintain at least 3 seconds to vehicle ahead, or perhaps at most 5% of the headway time shall be below 1 second). Similarly, warning threshold preset values for when a driver should be warned to correct headway time and following distance may be predefined, as well as additional warnings/instructions based on how long it should take a driver to correct headway time and following distance following such a warning. Additionally, driving parameters relating to lane departures may be set, as well as warning threshold preset values for when a driver should be warned of a lane departure, and additional warnings based on the actual amount of time to correct. Speed or stop sign response time, anticipatory turn signal use time, and see above for other possibilities, mirror usage frequencies and times.

In any event, based on the comparison operation(s) performed by the comparison module 340, a driver metric is determined which is reflective of conformance of the driver's actual behavior to the desired behavior (e.g. ‘keep at least 3 seconds to the vehicle ahead’).

Based on this metric, a determination may then be made as to whether a predefined warning threshold preset value (or the then-current threshold preset value) should be modified such that a modified warning threshold is used by the vehicle in providing one or more driver assistance warnings to the vehicle driver 310. Moreover, since the driver's identity is known and part of the information provided to the comparison module 340, the driver's past history can also be used, either to produce the metric or to inform the further determination as to whether the default (or then-current) warning threshold should be modified. In addition, or alternatively, an out-of-vehicle lesson 370 may be provided which focuses on and sensitizes the driver to the undesirable behavior.

A determination that a predefined warning threshold preset value should be modified may be made if, for example, a driver's reaction time materially deviates from a fleet average such that the driver's metric is below a predetermined metric, which is further indicative that the desired behavior has not been exhibited (e.g., as defined by desired driver behavior data 350).

The driver metric can also be based on a tendency to follow a vehicle too closely ahead, whether as a result of inattention or a vehicle cut-in. A measured reaction to this situation may be used in the scoring process. Here, the time to return from the minimum headway time to a safe value may be measured and further reflective of whether the driver's behavior is approximately the desired behavior.

In addition to driver reaction abilities and tendencies, the driver metric may optionally consider the location, time and conditions information noted above as also being possibly included in the driver behavior and event data 330 that can be provided to the driver behavior measurement module 320. This information 380 can be used to further evaluate a “raw” driver metric by taking into account conditions that might make it difficult for the driver to perform, such as a “low sun ahead” condition that makes it difficult for the driver to see. Low illumination levels or nighttime dazzling may make vision difficult. Many traffic participants or environmental elements may make it more difficult for a driver to focus on only the relevant ones. For example, shadows, particularly intermittent ones (e.g. from a line of trees along the road), may make detection of a dangerous situation more difficult, while narrow lanes may make collisions more likely.

Thus, one aspect of the invention relates to measuring driver reaction ability, reaction correctness, and various environmental factors to determine how closely the driver's behavior approximates a desired behavior, as may be defined by fleet manager/administrator as described above, such that driver-specific driving assistance can be provided in the form of at least one of a modified warning threshold 360 and/or an out-of-vehicle lesson 370.

The determination that a predefined warning threshold preset value should be modified may be informed by historical factors, such as if the undesirable driver behavior was the driver's first offense or whether there are other known issues relating to the driver's performance. Moreover, adjustments may take into account a ‘forgetting factor’, such as that present in Infinite Impulse response filters, where adjustment value at time t+1=factor*adjustment value at time t+(1−factor)*currently measured required adjustment value. As such, the closer the factor is to 1, more of the driver's past history is included in the analysis, and the closer it is to zero, more of the driver's recent behavior is accounted for in the analysis.

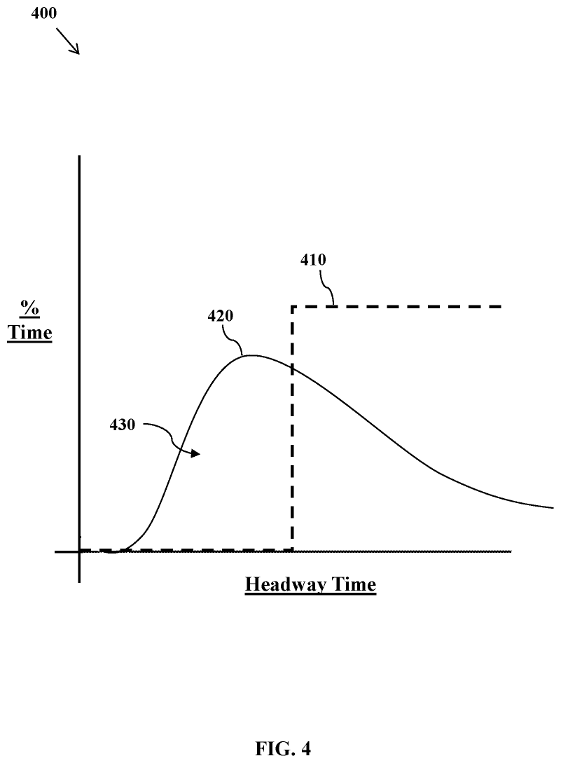

Details of when and how a modified warning threshold 370 can be determined are provided below with reference to FIGS. 4 and 5.

FIG. 4 depicts a diagram (histogram or distribution) comparing desired driver behavior and actual driver behavior with respect to headway time. In particular, diagram 400 graphs the driver's headway time (e.g., time between the time that one car finishes passing a fixed point and the instant that the next car begins to pass that point) as a function of the percentage of time that the driver stays at that headway time. Plot 410 is a plot of the desired behavior (e.g., maintain at least 3 seconds to vehicle ahead), while plot 420 is a plot of the driver's actual behavior. The area 430 under the curve of plot 420 that is outside of the desired behavior plot 410 is representative of an amount of undesirable driver behavior that is detected. If area 430 is unacceptably large, the driver may be aided with increased warnings, i.e., a modified threshold warning for headway time.

It should further be appreciated that any adjustment to a warning threshold may be proportional to the size of area 430. An adjustment thus might have the form of:

Adjustment=weight 1*average deviation from desired headway value+weight 2*fraction of total time spent below desired headway value.

In one embodiment, a simple version of this formula is that the adjustment is equal to the driver's shortcoming, for instance, responding 0.4 seconds too late leads to a warning coming 0.4 seconds earlier. However, in another embodiment a more advanced version might over adjust the warning initially (leading to an earlier, improved response, as the driver adapts), followed by a further adjustment back down to a lower value once the desired behavior is obtained or adequately approached.

The average deviation from the desired headway value is the horizontal distance between the mean of the distribution and the desired minimum headway (plot 410). The warning may then be given at the time:

Nominal value (e.g. 3 seconds)+adjustment

Furthermore, in addition to changing when the warnings occur (at a time earlier than usual, for example), the warnings may be tailored to the infraction or undesirable behavior, e.g., insufficient headway produces warnings that are clearly identifiable as headway related. Moreover, the warning may be changed to be of a different character (e.g., louder, more stringent, etc.) in response to the comparison module 340 providing a low driver metric. The driver's behavioral history thus follows with the driver's identity, also across and transferable to, various vehicles.

As noted above, the driver's identity, obtained via recognition or data entry, can be used to see how the driver has performed recently. For instance, if over the last week, the driver has developed a tendency to tailgate or otherwise follow vehicles ahead too closely, an earlier headway warning may be given, significantly earlier than, for example, the nominal 3 second value that normally produces warnings. This earlier warning is intended to push the actual driver's behavior back toward the desired value.

In addition, in response to being provide with modified warning thresholds, the amount of undesirable driver behavior (area 430) may be reduced over time (days, weeks, months), filtering it to remove transient, temporary responses. This could be in response to being more attentive in light of the modified warning thresholds, but may also be in response to individualized out-of-vehicle feedback/lessons. For example, FIG. 5 illustrates a diagram 500 showing how driver behavior can be improved with respect to headway time. Here, plot 510 once again represents the desired driver behavior with respect to headway time, while plot 520 represent actual driver behavior before any modification to the headway warning threshold was made or lessons/feedback provided. As with the example of FIG. 4, the area under the curve of plot 520 that is outside of the desired behavior plot 510 is representative of an amount of undesirable driver behavior that is detected.

Following a modification to the headway warning threshold or lessons/feedback being provided, in accordance with the principles of the invention, plot 530 may represent the driver's actual behavior one month later. As can be seen, the amount of undesirable behavior has decreased owing to the fact that the area under plot 530 that is outside of plot 510 is less than the area under plot 520 that is outside of plot 510. Finally, plot 540 may represent the driver's current actual behavior some number of days/weeks/months later, showing again improved conformity with the desired behavior.

In certain embodiments, a graph such as diagram 500 may also be used as a feedback mechanism to show the driver, without being compared with others, that her headway time is being pushed into the desired zone based on the fleet's policies. This form of individualized feedback need not look at specific events, but rather can be based on the statistical overview for a given type of problem (e.g. headway infractions).

It should further be appreciated that warning thresholds may also be adjusted down, at least to some predetermined minimum, for those drivers that have scored materially above the fleet average or otherwise exhibited high reaction abilities and exemplary tendencies. This may be desirable in order to reduce, for example, the amount of braking that would result from earlier/more frequent warnings, which is desirable to conserve fuel and vehicle wear and tear.

It should further be appreciated that the determination as to whether or not to modify a given warning threshold for a given driver (and by how much) may be based on other information, such as the current driver state (e.g., detected drowsiness, number of consecutive hours driving, etc.), vehicle location, etc.

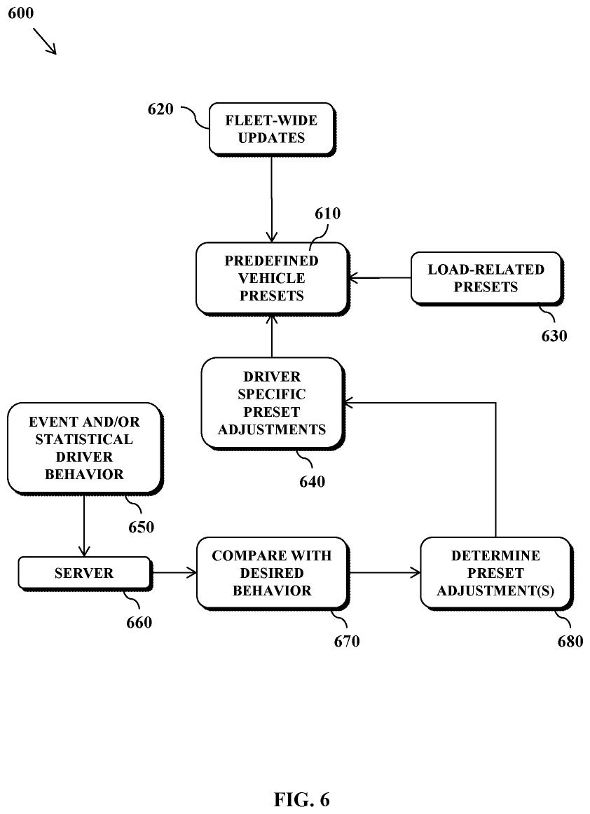

Referring now to FIG. 6, another aspect of the invention is described with reference to arrangement 600. The arrangement 300 includes a set of predefined warning threshold presets 610 which may be stored on the vehicle and used by the above-described driver warning and behavior modification device 200 to control when the vehicle provides warnings to the driver relating to, by way of example, headway time/safe following distance warnings, lane departure warnings based on “Time to Line Crossing” measurements, and warnings relating to braking and or obstacle avoidance events.

These predefined warning threshold presets 610 may be specific to the vehicle in which they are stored, and may be further based on or modified by fleet-wide updates 620 or load-related presets 630 (e.g., cargo or attached trailer characteristics). In addition, the warning threshold presets 610 may be modified based on driver-specific preset adjustments 640 that are similarly stored on or sent to the vehicle, such as those in the form of the modified warning threshold 360 described above with reference to FIG. 3 resulting from the operations described in connection therewith. In the same fashion as with FIG. 3, driver identification information is used to identify the driver and correspondingly access any locally-stored driver-specific preset adjustments that may exist, or to request remotely-stored driver-specific preset adjustments for the identified driver.

Together, fleet-wide update 620, load-related presets 630 and the driver-specific preset adjustments 640 are combined, typically by addition, with limits applied to constrain the final adjusted value to lie within bounds, to produce or modify the predefined warning threshold presets 610 (which may be vehicle-specific) so as to control exactly when the driver warning and behavior modification device will provide driver warnings in a manner tailored to the particular driver, as well as to the particular circumstances under which the driver will be reacting to the surrounding conditions, thereby improving the ability of the driver to adequately react to a given situation, as exhibited above with respect to FIG. 5.

In addition, the arrangement 600 of FIG. 6 further comprises collecting event and/or statistical driver behavior data 650 from the driver warning and behavior modification device 200 of the vehicle 112, as described above with reference to block 330 of FIG. 3. This event and/or statistical driver behavior data 650 may include how a driver behaves generally and/or in relation to one or more vehicle events, such as a lane departure, headway time, excessive braking, excessive lateral acceleration, rollover, traffic signs, roadway geometry, deviations, etc. This data 650 may then be transmitted to server 660, which may include the comparison module 340 described above with reference to FIG. 3.

Data 650 may then be compared (at block 670) with desired driver behavior data (e.g., data 350 of FIG. 3) and used in a fashion analogous to that of FIG. 3 to determine whether the current driver-specific preset adjustments 640 should be updated to reflect the driver's most current event and/or statistical driver behavior data 650 (at block 680), which in turn would be used to update the warning threshold presets 610 used to control exactly when the driver warning and behavior modification device will provide driver warnings.

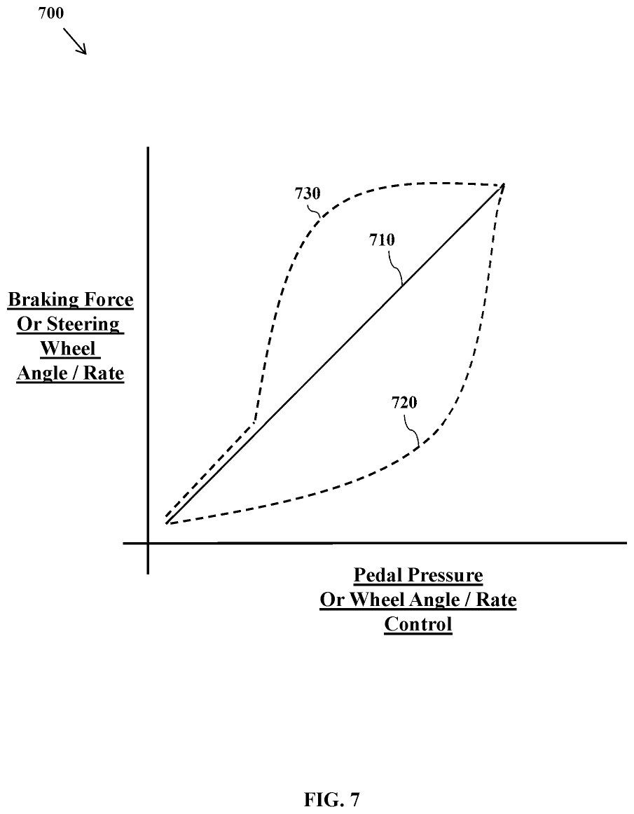

It should further be appreciated that the adjusted, individualized, vehicle-dependent, fleet-controlled parameters may be used to modify the manner in which the vehicle physically behaves. This control or modification may consist of altering the vehicle's steering and/or braking behavior, whereby an adjustment may be made to render the vehicle's steering and/or braking more or less sensitive. By way of a non-limiting example, FIG. 7 shows such an altered characteristic, whereby the input pedal pressure or steering wheel angle or rate is related to the vehicle braking force or the vehicle's (on-the-pavement) wheel angle or rate. Plot 710 represents the uncompensated, normal characteristic. Those characteristics that begin with the same slope as the uncompensated, normal characteristic 710 will initially behave just like the standard vehicle, allowing for normal vehicle operation and feel most of the time.

However, a more forgiving characteristic (plot 720) is achieved by decreasing the sensitivity relating the input (i.e., input pedal pressure or steering wheel angle/rate) to the output (i.e., vehicle braking force or vehicle's wheel angle/rate). Conversely, a less forgiving, more sensitive, characteristic (plot 730) may be achieved by increasing the amplification (curve slope) of the above input to output relation. It should be appreciated that numerous functional relationships are possible. Further on in the curve (to the right in FIG. 7), more amplification is applied, and the driver is assisted more. In this fashion, the aforementioned individualized, vehicle-dependent, fleet-controlled parameters may be used to modify the vehicle's physical behavior or otherwise control the vehicle in an individualized manner, in particular to control the vehicle's braking and steering components and circuitry in a manner which takes into account the driver's behavior, as determined in accordance with the above description.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

The term “server” means a functionally-related group of electrical components, such as a computer system that may or may not be connected to a network and which may include both hardware and software components, or alternatively only the software components that, when executed, carry out certain functions. The “server” may be further integrated with a database management system and one or more associated databases.

In accordance with the descriptions herein, the term “computer readable medium,” as used herein, refers to any non-transitory media that participates in providing instructions to the processor 230 for execution. Such a non-transitory medium may take many forms, including but not limited to volatile and non-volatile media. Non-volatile media includes, for example, optical or magnetic disks. Volatile media includes dynamic memory for example and does not include transitory signals, carrier waves, or the like. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, PROM, and EPROM, a FLASH-EPROM, any other memory chip or cartridge, or any other tangible non-transitory medium from which a computer can read.

In addition and further in accordance with the descriptions herein, the term “logic,” as used herein, with respect to FIG. 2, includes hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A driver warning and behavior modification device comprising:
a signal interface to a plurality of sensors;
a transceiver module;
a memory configured to store a plurality of instructions and to store a plurality of warning threshold preset values used to provide driver assistance warnings; and
a processor, coupled to the plurality of sensors via the signal interface, transceiver module and memory, wherein the processor is configured to execute the plurality of instructions to:
identify the driver of the vehicle,
receive, from the plurality of sensors, driver behavior data corresponding to the driver,
receive, from a server via the transceiver module, one or both of a modified warning value specific to the identified driver and desired driver behavior data, wherein the modified warning value is based at least in part on a determined amount of deviation of the driver behavior data for the identified driver from the desired driver behavior data,
update one or more of the plurality of warning threshold preset values based on the modified warning value, and
provide a driver assistance warning to the identified driver in accordance with the updated one or more of the plurality of warning threshold preset values.

2. The device of claim 1, wherein the processor is further configured to:
transmit, using the transceiver module, driver identification information and the driver behavior data to the server, and
receive, from the server, the modified warning value specific to the identified driver.

3. The device of claim 1, wherein the processor is further configured to execute the plurality of instructions to determine a metric based on the driver behavior data that reflects a relative conformance of the driver's actual behavior to desired behavior.

4. The device of claim 1, wherein the processor is configured to receive image data from a driver facing camera in the vehicle, and wherein the processor is further configured to identify the driver based on said image data.

5. The device of claim 1, wherein the driver behavior data corresponds to one or more of average following distance, average headway time, average response to speed signs, anticipation of needed slowing, lane departure activity, average rate of braking, and average rate of acceleration.

6. The device of claim 1, wherein the driver behavior data corresponds to one or more of a corrective reaction time after a warning for one or more of exceeding a minimum safe following distance, failing to adhere to a predefined headway time, an unintentional lane change, an excessive braking, and an excessive acceleration.

7. The device of claim 1, wherein the driver behavior data further comprises one or more of a location, time and conditions at the time the driver behavior data was received from the plurality of sensors.

8. The device of claim 1, wherein the desired driver behavior data comprises predefined fleet-wide driving parameters and/or default warning thresholds.

9. The device of claim 1, wherein the modified warning value is further based on a history of behavior for the driver for the type of event and a deviation of that behavior from an average behavior for a plurality of other drivers.

10. The device of claim 1, wherein the driver behavior data is used to modify a sensitivity of one or both of a steering wheel and a brake pedal of the vehicle.

11. A method for providing driver warnings and behavior modifications,
the method comprising:
storing, in a vehicle, a plurality of warning threshold preset values used to provide driver assistance warnings;
identifying a driver of the vehicle based on driver identification information;
receiving, from a plurality of sensors, driver behavior data corresponding to the driver;
comparing the received driver behavior data for the identified driver to desired driver behavior data to determine an amount of deviation of the driver behavior data for the identified driver from the desired driver behavior data;
determining a modified warning value specific to the identified driver based at least in part on the determined amount of deviation;
updating one or more of the plurality of warning threshold preset values based on the modified warning value; and
providing a driver assistance warning to the identified driver in accordance with the updated one or more of the plurality of warning threshold preset values.

12. The method of claim 11, further comprising:
transmitting, from the vehicle to a server, driver identification information and the driver behavior data; and
receiving, by the vehicle from the server, the modified warning value specific to the identified driver.

13. The method of claim 11, wherein the method further comprises determining a metric based on the driver behavior data that reflects a relative conformance of the driver's actual behavior to desired behavior.

14. The method of claim 11, wherein identifying the driver comprises receiving, by the data collection and processing device, image data from a driver facing camera in the vehicle, and identifying the driver based on said image data.

15. The method of claim 11, wherein the driver behavior data corresponds to one or more of average following distance, average headway time, average response to speed signs, anticipation of needed slowing, lane departure activity, average rate of braking, and average rate of acceleration.

16. The method of claim 11, wherein the driver behavior data further corresponds to one or more of a corrective reaction time after a warning for one or more of exceeding a minimum safe following distance, failing to adhere to a predefined headway time, an unintentional lane change, an excessive braking, and an excessive acceleration.

17. The method of claim 11, wherein the driver behavior data further comprises one or more of a location, time and conditions at the time the driver behavior data was received from the plurality of sensors.

18. The method of claim 11, wherein the desired driver behavior data comprises predefined fleet-wide driving parameters and/or default warning thresholds.

19. The method of claim 11, wherein the modified warning value is further based on a history of behavior for the driver for the type of event and a deviation of that behavior from an average behavior for a plurality of other drivers.

20. The method of claim 11, further comprising modifying a sensitivity of one or both of a steering wheel and a brake pedal of the vehicle based on the driver behavior data.

21. A system for providing user-specific driver assistance, the system comprising the driver warning and behavior modification device and the server of claim 1.
